(19) United States
(12) Patent Application Publication
(10) Pub. No.: US 2012/0279268 A1
(43) Pub. Date: Nov. 8, 2012

(54) Forging of an Annular Article with Electric Induction Heating

(76) Inventors: Don L. LOVELESS, Rochester, MI (US); Douglas R. BROWN, Rochester, MI (US); Joseph C. CERNY, Put In Bay, OH (US)

(21) Appl. No.: 13/463,279

(22) Filed: May 3, 2012

Related U.S. Application Data
(60) Provisional application No. 61/481,962, filed on May 3, 2011.

(51) Int. Cl. H05B 6/10; B21B 19/14

(52) U.S. Cl. 72/69

(57) ABSTRACT

Roll forging of an annular article of manufacture is accomplished with electric induction heating of the workpiece simultaneously during the roll forging process as required to keep the workpiece at optimum forging temperature during the roll forging process.

### CROSS REFERENCE TO RELATED APPLICATIONS

This application claims the benefit of U.S. Provisional Application No. 61/481,962, filed May 3, 2011, hereby incorporated by reference in its entirety.

### FIELD OF THE INVENTION

The present invention relates to electric induction heating of a ring-shaped workpiece to maintain forging temperature while simultaneously forge rolling the workpiece to the final size of the forged ring.

### BACKGROUND OF THE INVENTION

The process of roll forming large ring-shaped workpieces, such as bearing and gear rings, involves placing a hollow cylindrical metal preform heated to forging temperature on a roll forming machine where the preform cross section is progressively reduced. During the roll forming of large rings (typically from 4 feet to 16 feet in inner or outer diameter), the ring's metal decreases in temperature due to thermal radiation, convection and/or conduction. When sufficient temperature is lost, it is common practice to remove the partially formed ring from the roll forming machine and place it in a furnace to replace the heat energy lost during rolling. The partially formed ring is then returned to the roll forming machine for further reduction of cross section and increase in diameter. This reheat process is repeated until the desired diameter and cross sectional dimensions of the manufactured article are obtained. The process of reheating the ring in a furnace significantly increases overall process time and requires a large furnace with low intermittent utilization. Further the additional time required by off-line furnace reheat causes an undesirable increase in grain growth and scale in the ring's metal particularly when forming steel rings.

It is one object of the present invention to eliminate the necessity of periodic reheating of an annularly-shaped preform during formation into an article of manufacture in a forging process.

It is another object of the present invention to decrease the magnitude of grain growth and the amount of material lost to scale formation during a roll forging process for an annularly-shaped article of manufacture.

### BRIEF SUMMARY OF THE INVENTION

In one aspect the present invention is apparatus for, and method of, forging a metal preform with a ring rolling apparatus while simultaneously applying low frequency induction heating to the preform to impart thermal energy to the preform so that an annular article can be manufactured without intermittent furnace heating of the preform.

In another aspect the present invention is a process for forging an annular article from an open cylindrical workpiece with electric induction heating. The open cylindrical workpiece is inserted in a forge ring rolling apparatus so that the forge ring rolling apparatus can forge ring roll the workpiece into the annular article. A closed magnetic core of at least one C-core type inductor is inserted around a cross sectional region of the open cylindrical workpiece, and a low frequency alternating current is supplied to a solenoidal coil surrounding a cross sectional region of the magnetic core of at least one C-core type inductor to establish a magnetic field that couples with the open cylindrical workpiece to heat the workpiece during the forge ring rolling process.

In another aspect the present invention is a forge ring rolling and induction heating apparatus. The apparatus comprises a ring rolling apparatus for forge ring rolling of a workpiece that can be an open cylindrical workpiece and at least one C-core type inductor. Each of the C-core type inductors has an openable closed magnetic core for insertion around a cross sectional region of the workpiece during the ring rolling process and a solenoidal coil surrounding a cross sectional region of the openable closed magnetic core. At least one alternating current power source supplies a low frequency current to the solenoidal coil of each C-core type inductor to inductively heat the workpiece during the ring rolling process that produces an annular article of manufacture.

The above and other aspects of the invention are set forth in this specification and the appended claims.

### BRIEF DESCRIPTION OF THE DRAWINGS

The appended drawings, as briefly summarized below, are provided for exemplary understanding of the invention, and do not limit the invention as further set forth in this specification and the appended claims.

FIG. 1(a) and FIG. 1(b) illustrate in cross sectional elevation and top plan views, respectively, a typical C-core type inductor surrounding an annular workpiece.

FIG. 2(a) diagrammatically illustrates a simplified ring rolling apparatus at the beginning of the ring rolling process with workpiece 24 having opening 24′ and axial center C_{WP}.

FIG. 2(b) is a cross sectional side view of the ring rolling apparatus shown in FIG. 2(a) through line A-A.

FIG. 3(a) diagrammatically illustrates a simplified ring rolling apparatus at the process stage of ring rolling when the inside diameter of the workpiece ring has been expanded sufficiently to allow the introduction of a magnetic core of a C-core type inductor around a cross sectional segment or region of the workpiece ring to boost and maintain forging temperature by electric induction heating.

FIG. 3(b) illustrates in cross sectional side view the ring rolling apparatus shown in FIG. 3(a) through line B-B′.

FIG. 3(c) illustrates in cross sectional side view one of the two C-core type inductors shown in FIG. 3(a) through line B-C with the “I” section of the magnetic core of the C-core type inductor shown in the open position.

FIG. 3(d) illustrates in cross sectional side view one of the two C-core type inductors shown in FIG. 3(a) through line B-C with the “I” section of the magnetic core of the C-core type inductor shown in the closed position for induction heating of the workpiece ring while in the ring rolling apparatus.

FIG. 4(a), FIG. 4(b) and FIG. 4(c) illustrate (respectively in top plane view; cross sectional side view through line D-D; and cross sectional side view through line D-E) movement of the idler roll, axial rolls and the C-core type induction heating apparatus relative to the drive roll as the workpiece ring cross section is progressively reduced and the workpiece ring inner and outer diameters are progressively expanded from that shown in FIG. 3(a).

FIG. 5(a), FIG. 5(b) and FIG. 5(c) illustrate (respectively in top plane view; cross sectional side view through line F-F; and cross sectional side view through line F-G) the simplified ring rolling apparatus shown in FIG. 3(a) with the C-core type inductors positioned at the end of the ring rolling process.

FIG. 5(d) illustrates in cross sectional side view one of the two C-core type inductors shown in FIG. 5(a) through line F-G with the “I” portion of the magnetic core of the C-core type inductor shown in the open position.

FIG. 6 illustrates one example of the layout of a rail or track on which the C-core type induction heating apparatus can be mounted to facilitate its movement to maintain centering of the heated workpiece ring within the opening (window) of the magnetic core of the C-core type induction heater as the forge ring rolling process progresses.

### DETAILED DESCRIPTION OF THE INVENTION

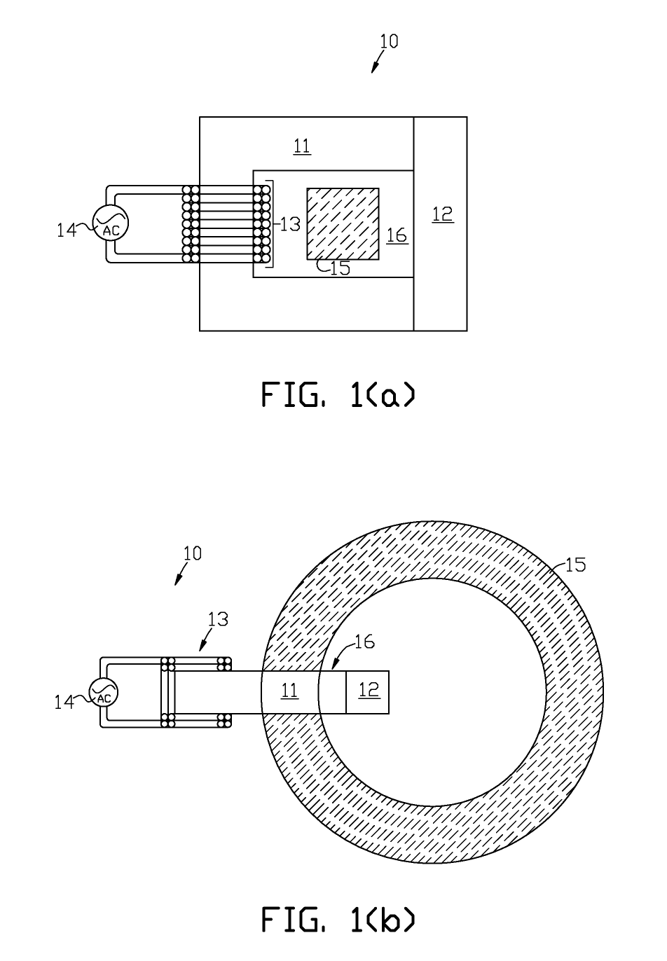

As further described below the forging of an annular article with electric induction heating of the present invention utilizes low frequency induction heating that can also be referred to C-core heating, or C-core type heating. As used herein the term “annular” is used interchangeably with the term “ring” that may be, by way of example and not limitation, a forged bearing or gear ring. As used herein the term “preform” and the term “ring” are used interchangeably to describe the forging workpiece that results in the manufactured ring product or article. In C-core heating, low frequency electric current is supplied to an induction coil that surrounds a portion of magnetic core material making up a C-core shaped inductor. The magnetic core material forms a closed loop and the ring to be heated passes through the closed loop. As a result, current is induced in the ring which produces heat by the Joule effect. C-core heating has significant advantages over other forms of induction heating. Firstly the ring to be heated passes through the opening in the magnetic core and not through a closed induction coil. This allows for heating of rings of varying cross sectional shapes without the need for change in the size of the heating coil. Secondly the magnetic core can be composed of multiple sections; typically at least a “C” shaped section 11 and an “I” shaped section 12 as shown in FIG. 1(a) and FIG. 1(b). This allows for insertion and extraction of the ring to be heated by moving the “I” shaped section to open the loop formed by the magnetic core; alternatively the “C” shaped section may be moved although such movement may be more complicated if the coil is wound around the “C” shaped section. Thirdly insertion and extraction of the ring to be heated is accomplished without opening and closing a high current electrical connection, and fourthly the electric current induced in the ring to be heated flows circumferentially around the ring to provide heating that is uniformly distributed around the circumference of the heated ring.

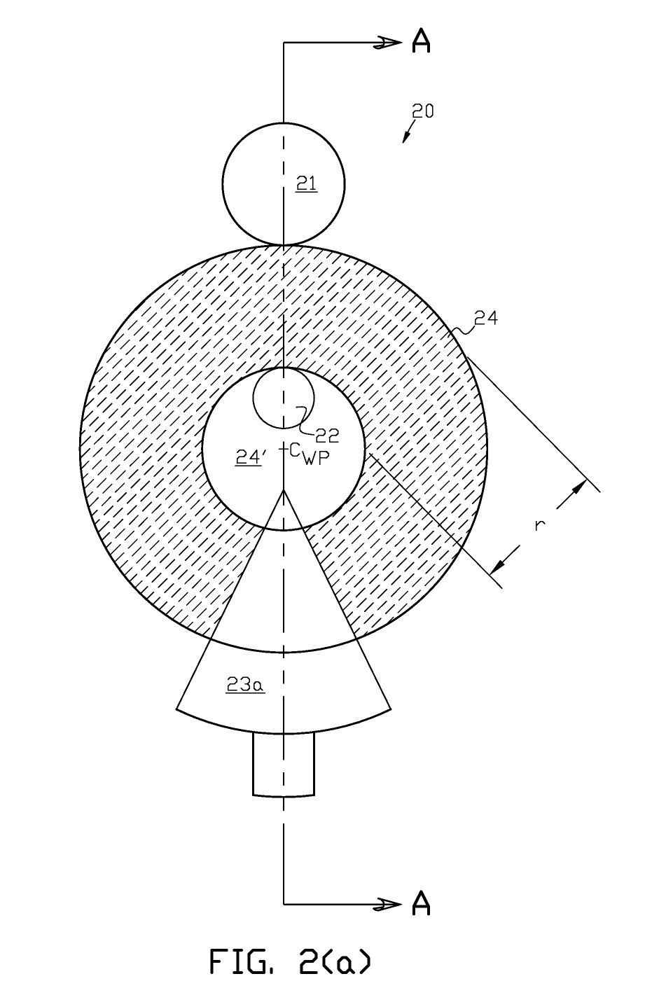

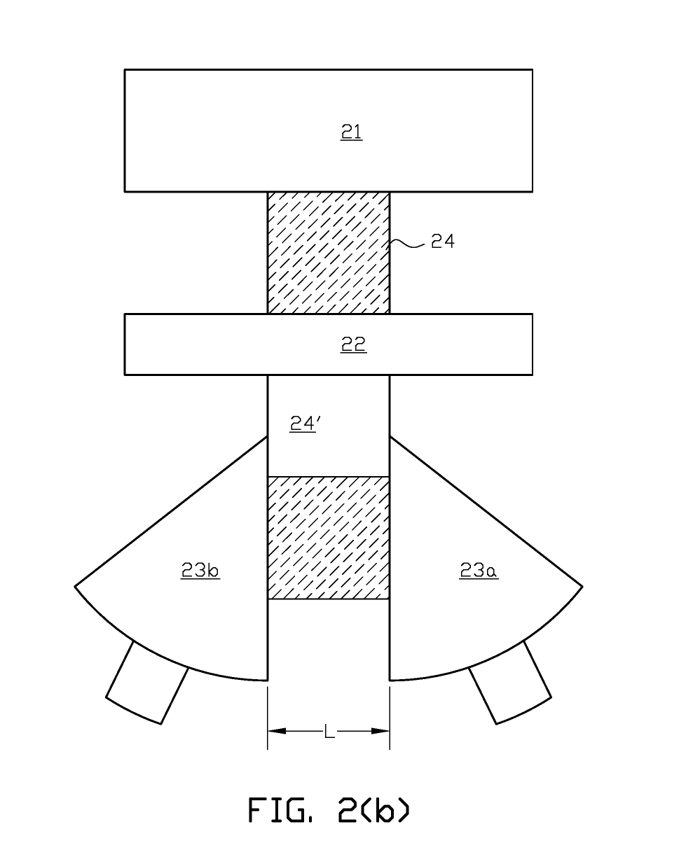

Hot ring rolling is a form of forging used to produce a continuous metal ring with an inner or outer diameter that is typically in the range from about 25 cm to at least 4.5 meters. FIG. 2(a) and FIG. 2(b) illustrate the basic components of ring rolling apparatus 20 with workpiece 24 inserted in the apparatus. The basic components are drive (main) roll 21; idler roll 22 and two conical shaped axial (edging) rolls 23a and 23b, which is shown in FIG. 2(b). Workpiece 24 is a generally cylindrical preform with a hole (opening) 24′ pierced through the interior (generally axial-centered) of the cylindrical preform that is placed over idler roll 22 and between the axial rolls 23a and 23b as shown in the figures so that the outer diameter of the open cylindrical workpiece is adjacent to the surface of the drive roll; the inner diameter of the workpiece is adjacent to the surface of the idler roll; and the opposing ends (of the length) of the workpiece face the surfaces of the axial rolls. Pressure is applied between drive roll 21 and the idler roll 22 while the drive roll is rotated to cause a reduction of the preform cross section in the radial dimension, r. At the same time pressure is applied between the axial rolls 23a and 23b to cause a reduction of the preform in the longitudinal dimension, L. As this forging process continues, the workpiece becomes smaller in cross section while forming a continuous ring (annulus) with increasing inner and outer diameters.

Rings generally larger than one meter in inner or outer diameter lose significant heat by conduction to the forming rolls and supports, as well as by convection and radiation during the roll forming process. With the apparatus and method of the present invention, thermal energy is inductively coupled to the ring during the roll forming process to reduce, or eliminate a loss of temperature, and therefore avoid the need to interrupt the roll forming process to reheat the partially formed ring in an off-line oven or furnace.

There is shown in FIG. 1(a) and FIG. 1(b) one example of a C-core type inductor 10 used in the present invention. C-core type inductor 10 comprises a stationary core segment 11 and a moveable core segment 12. The core may be formed from magnetic materials known in the art, such as a laminated magnetic material, or a powder-based magnetic material, such as ferrite or iron based material. A multi turn solenoid coil 13 surrounds a portion of the stationary core segment and is connected to a power source 14 of low frequency alternating current. The term “low frequency” as used in this example is within the range of approximately 1,000 Hertz or less. Since depth of current penetration is inversely proportional to applied frequency, low frequency can provide a significant depth of induced heating energy during the ring forging process as the magnetic flux generated by low frequency current flow in the magnetic core penetrates the region of the workpiece within the core. Although two segments make up the inductor in FIG. 1(a) and FIG. 1(b) other number of segments may be used, and the two or more segments may be other than C-shaped and I-shaped as required for a particular application as long as the segments making up the inductor form a substantially closed magnetic core during the electric induction heating process; for convenience the term “C-core type inductor” is used to include these cores composed of different segments.

The flow of low frequency alternating current in solenoidal coil 13 establishes a magnetic field in and around C-core segments 11 and 12, which in turn, magnetically couples with workpiece 15 that is located in the closed C-core's opening 16 as shown in FIGS. 1(a) and FIG. 1(b), to induce alternating current flow therein. Current flow in the workpiece generates heat by the Joule effect.

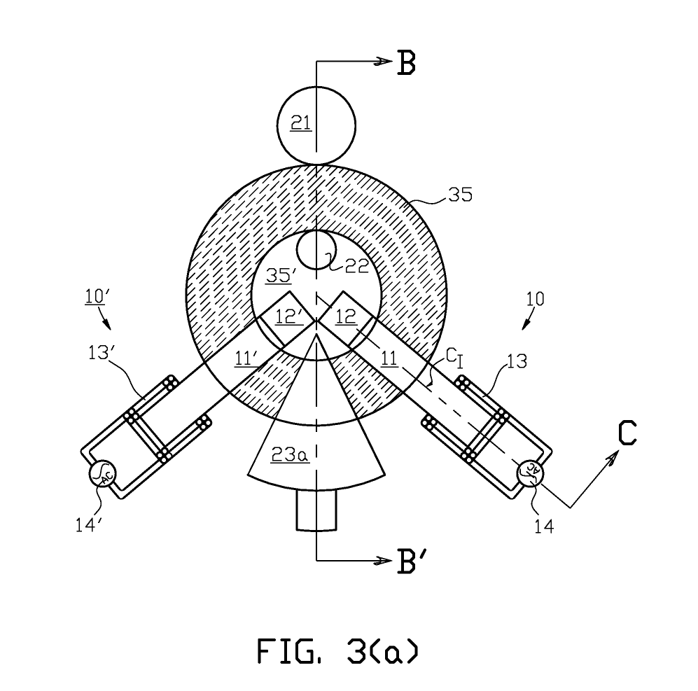

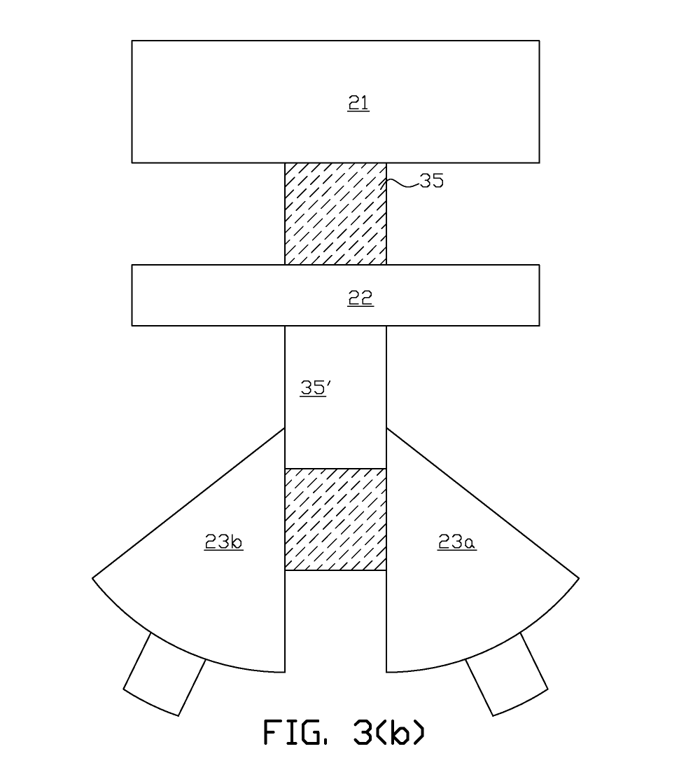

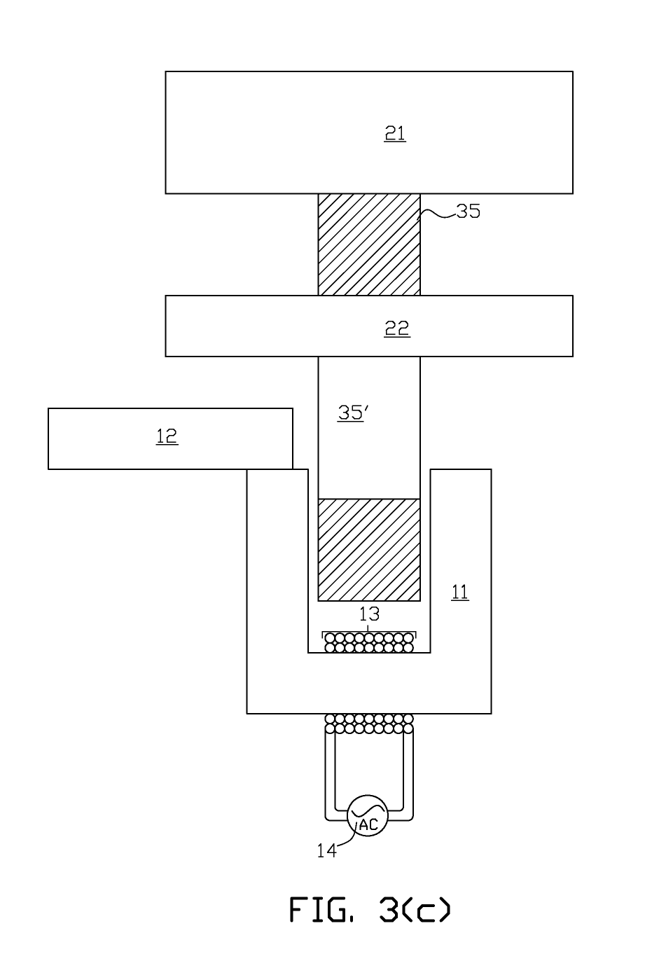

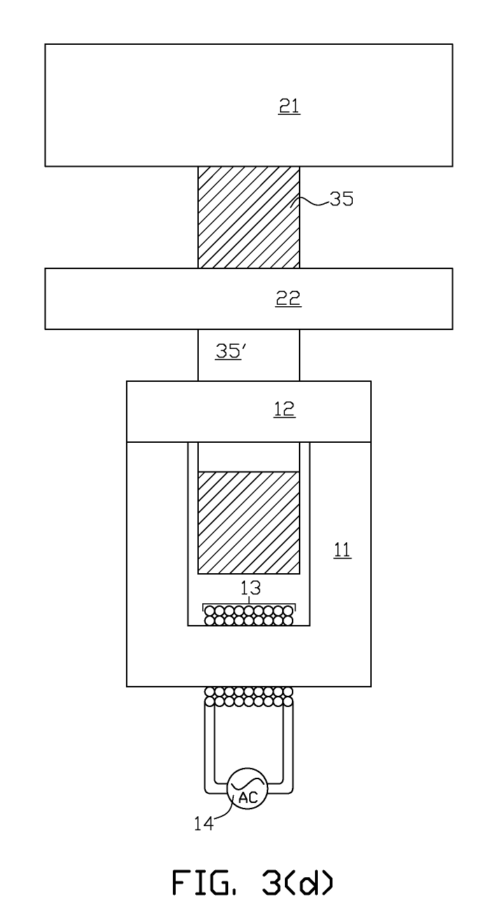

As shown in FIG. 3(a) through FIG. 3(d), typically after the beginning of the ring rolling process, the inside diameter of the ring is sufficiently large and the cross section sufficiently small to allow for the positioning of C-core section 11 around a cross sectional segment of ring 35 as seen in FIG. 3(c), and insertion of movable core section 12 to a position that closes the magnetic core circuit about ring 35 as seen in FIG. 3(d) with generally gapless interfaces between the two C-core sections, which can be referred to as a closed magnetic core. Insertion time of the closed magnetic core will depend upon the workpiece and core dimensions for a particular application. After closure of the magnetic core circuit, alternating current from power supply 14 is applied to solenoid induction coil 13 which generates a magnetic field in and around C-core sections 11 and 12 which in turn induces alternating current flow in ring 35. Current flow in ring 35 generates heat by the Joule effect in the ring that is sufficient to maintain, or raise the temperature of ring 35 to allow for uninterrupted roll forming to a smaller cross section and larger inner and outer diameters. Two C-core type induction heaters 10 and 10′ are utilized in the example of the invention shown in the figures, with operation of the second C-core type induction heater being similar to that of the first induction heater. Each induction heater 10 or 10′ comprises separate C-core sections 11 and 12, or 11′ and 12′ and solenoidal induction coil 13 or 13′ as shown in the figures. Power supplies 14 and 14′ may be a single power supply or two separate power supplies, and may have a fixed or variable low frequency output. The power supplies may be remotely located from induction heaters 10 and 10′ and suitably connected to the solenoidal induction coils. In all examples of the invention, induction heating may be optionally continuous or intermittent during the ring rolling process, and induction heating may be optionally accomplished during intermittent stopping of the ring rolling process.

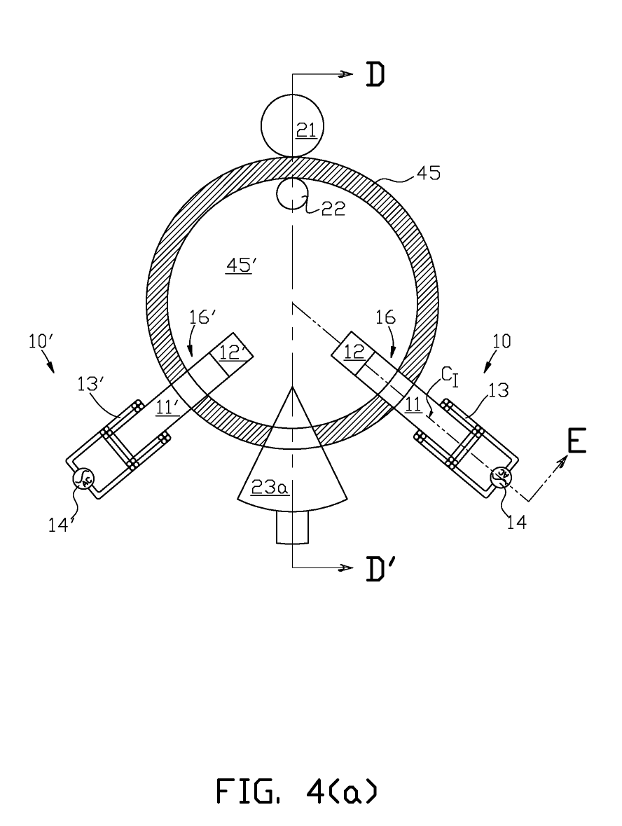

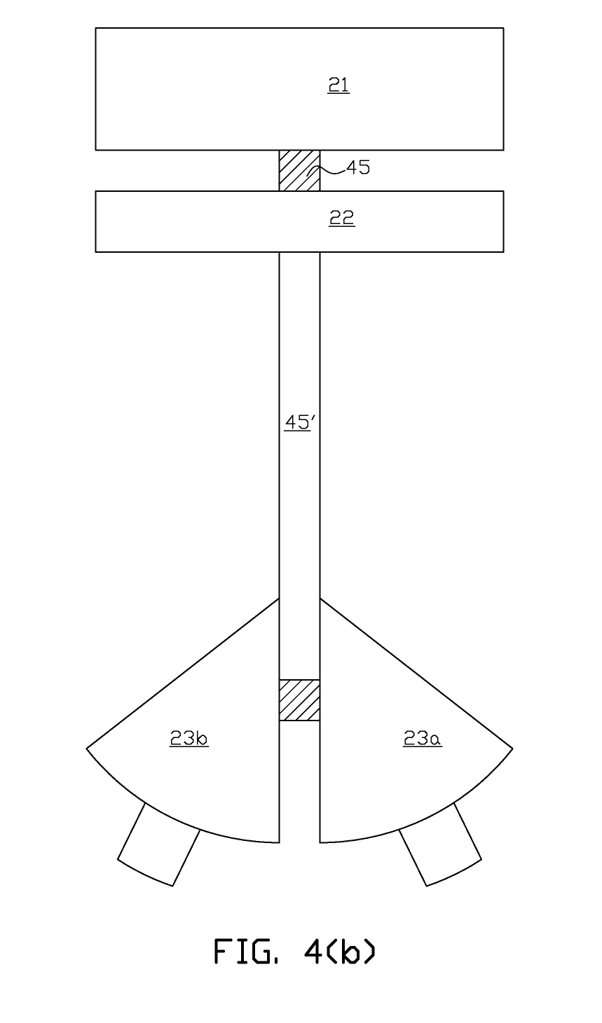

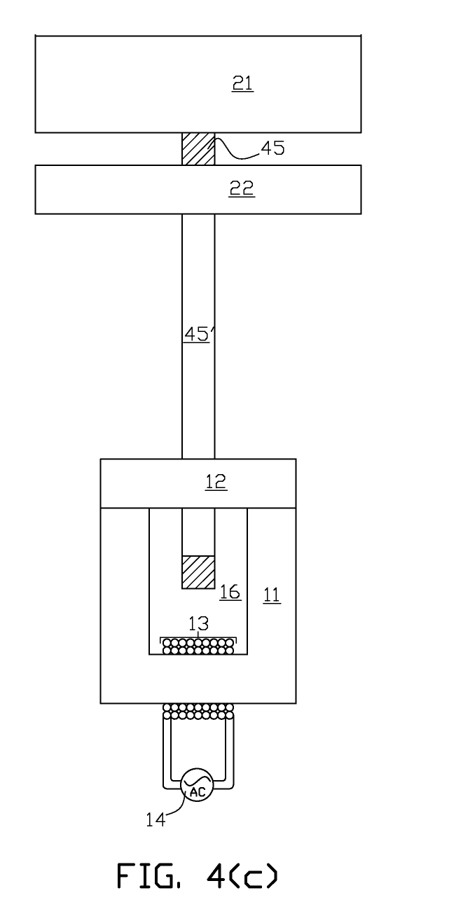

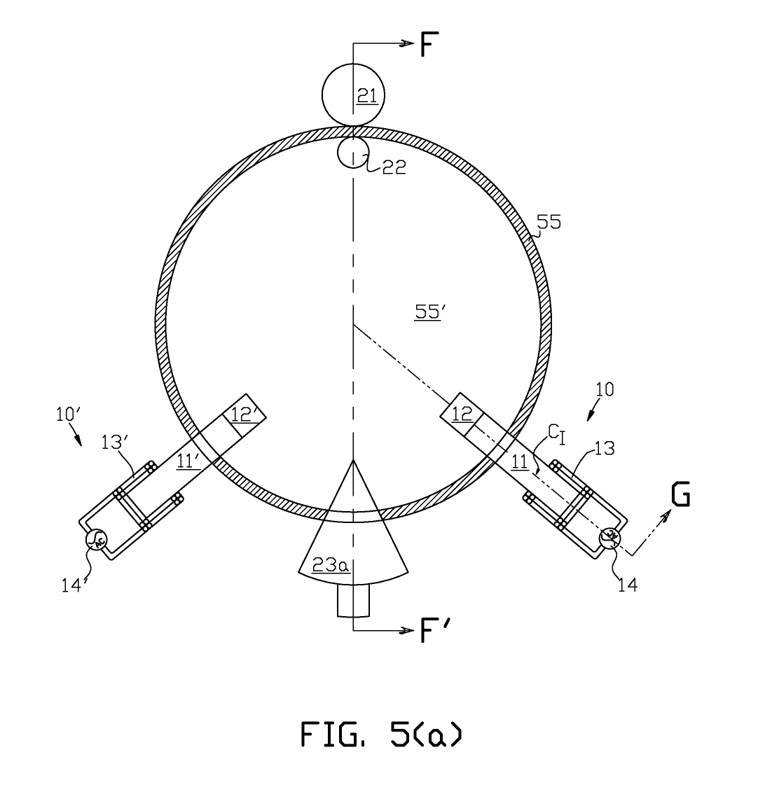

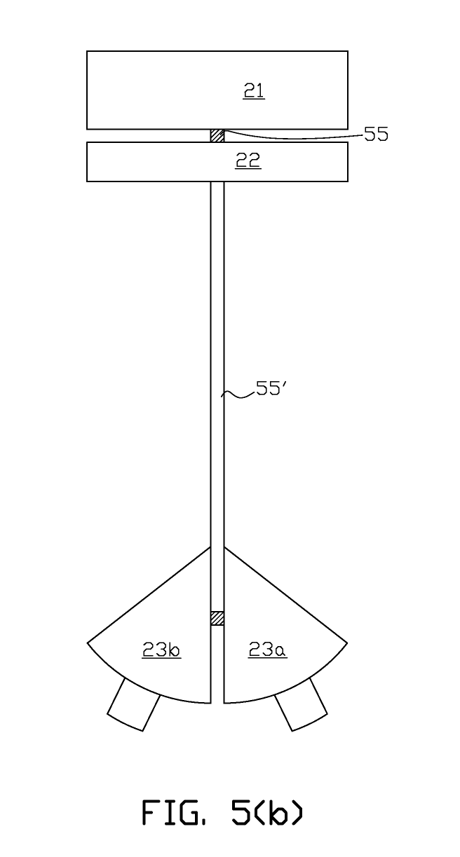

As shown in FIG. 4(a) through FIG. 4(c), as the ring rolling process continues, the inner and outer diameters of the workpiece ring increase necessitating outward movement of the C-core type magnetic core to keep the cross section of the progressively forged ring 45 within C-core openings 16 and 16′ (also referred to as the core window). Alternatively in other examples of the invention, the ring rolling apparatus may be moved while the C-core type magnetic core is held in position or coordinately moved with the ring rolling apparatus to keep the cross section of the progressively forged ring within the C-core opening.

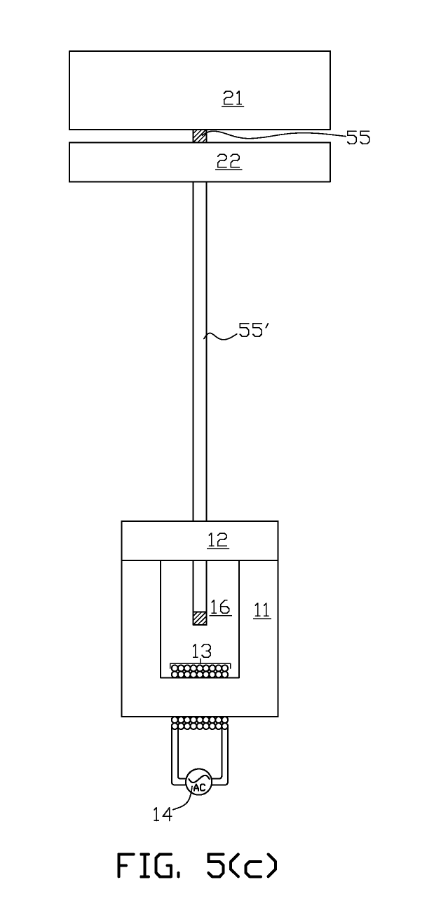

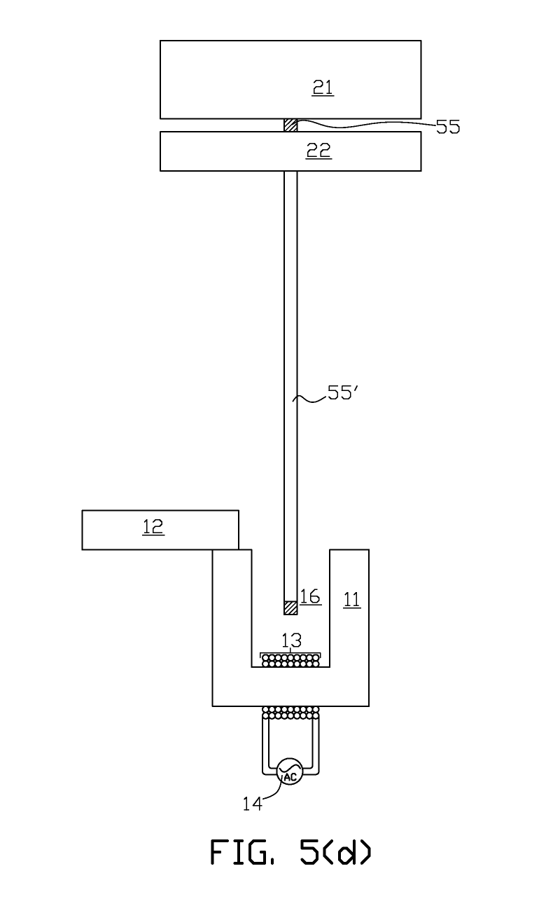

The ring rolling process is complete when the manufactured ring 55, with final inner and outer diameters, is obtained as shown in FIG. 5(a) through FIG. 5(d). At this time in the forging process, alternating electric current from power supplies 14 and 14′ is interrupted and heating of the ring stops. As shown in FIG. 5(d) movable core section 12 is withdrawn to a position that allows movement of the C-core type inductor away from the ring to allow for removal of the manufactured ring from the ring rolling apparatus.

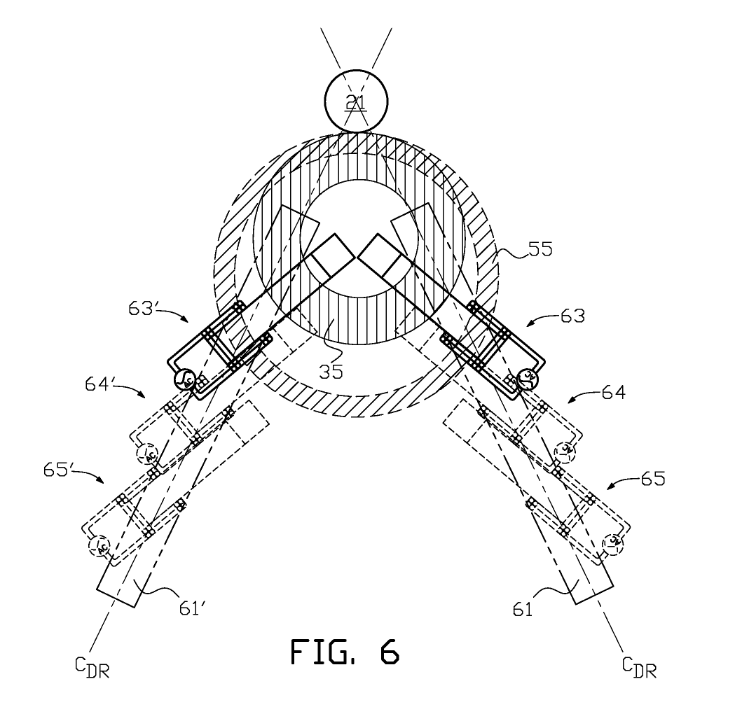

One example of an inductor movement apparatus is shown in FIG. 6. Linear tracks or rails 61 and 61′ (diagrammatically illustrated in rectangular dashed outlines) can carry and move the C-core type inductors as shown in FIG. 6. In this example the positioning of tracks or rails 61 and 61′ relative to drive roll 21 is such that the C-core type inductors 10 and 10′ are movable from the start-of-heating positions 63 and 63′ (shown in FIG. 3(a) and in solid lines in FIG. 6) to the end-of-heating positions 64 and 64′ (shown in FIG. 5(a) and in dashed lines in FIG. 6) while keeping the cross section of the ring within the core opening. After ring rolling is completed, the C-core type inductors 10 and 10′ can be moved further in an outward direction to the workpiece unload positions 65 and 65′ (shown in dashed lines in FIG. 6) to allow for removal of manufactured ring 55 (article of manufacture) from the ring rolling apparatus. In the particular example shown in FIG. 6, linear motion of the C-core type inductors is centered along axis C_{DR} passing through the center of drive roll 21 while the central axis C_{I} of each C-core inductor (FIG. 3(a)) does not rotate as the workpiece's thickness decreases and the inner and outer diameters increase until the workpiece has been worked to its final dimensions as a manufactured ring product. While the alternate positions (in dashed lines in FIG. 6) illustrate movement of the magnetic core, solenoidal coil and power source for each C-core type inductors 10 and 10′, the inductor movement apparatus can alternatively move the magnetic core and solenoidal coil while the power source is located remotely and connected to the solenoidal coil by suitable electrical connecting elements such as cables or busbar.

In other examples of the invention relative movement of the C-core type inductors can be accomplished by means other than described in this example, such as by overhead gantry or robot.

While the examples of the present invention illustrated in FIG. 2(a) through FIG. 6 utilize a ring rolling apparatus having two C-core type inductors, in other examples of the invention, one or more C-core type inductors may be used depending on a particular application and/or the size or dimensions of the workpiece. When more than one C-core type inductor is used, the power supplied to the coil of each C-core type inductor must be of identical phase and amplitude, and may be from a common source, or separate sources with synchronous outputs.

While the examples of the present invention illustrate the basic components of a ring rolling apparatus, the claims are not limited to such apparatus; the C-core type inductors and induction heating process of the claimed invention can be used with known ring rolling apparatus that include additional components and known ring rolling processes that include additional process steps.

While the above examples of the invention apply to a circular (zero eccentricity) ring rolling forge process, the present invention can also be utilized for forging workpieces with eccentricity ranging from greater than zero to one (elliptical to hyperbolic) provided that the mechanical rolling apparatus is appropriately configured.

The open cylindrical workpiece of the present invention need not be formed entirely from an electrically conductive composition; the composition may be partially electrically conductive as long as the induced electric heating is sufficient to keep the workpiece (preform) at a temperature for working in the ring rolling apparatus.

The present invention has been described in terms of preferred examples and embodiments. Equivalents, alternatives and modifications, aside from those expressly stated, are possible and within the scope of the invention.

1. A method of forging an annular article with electric induction heating, the method comprising the steps of:
inserting an open cylindrical workpiece in a forge ring rolling apparatus;
forge ring rolling the open cylindrical workpiece in the forge ring rolling apparatus;
inserting a closed magnetic core of at least one C-core type inductor around a cross sectional region of the open cylindrical workpiece; and
supplying a low frequency alternating current to a solenoidal coil surrounding a cross sectional region of each one of the at least one C-core type inductor to establish a magnetic field that couples with the open cylindrical workpiece while forge ring rolling the open cylindrical workpiece in the forge ring rolling apparatus.

2. The method of forging an annular article with electric induction heating of claim 1 further comprising the step of moving each one of the at least one C-core inductor during the step of forge ring rolling the open cylindrical workpiece in the forge ring rolling apparatus to maintain the cross sectional region of the open cylindrical workpiece within the closed magnetic core of each one of the at least one C-core type inductor as the cross section of the open cylindrical workpiece decreases and the inner and outer diameters of the open cylindrical workpiece increases.

3. The method of forging an annular article with electric induction heating of claim 2 wherein the step of moving each one of the at least one C-core inductor further comprises moving each one of the at least one C-core inductor linearly outwards from the axial center of the open cylindrical workpiece.

4. The method of claim 2 further comprising the step of removing the closed magnetic core of each one of the at least one C-core type inductor from around the cross sectional region of the open cylindrical workpiece.

5. The method of claim 1 further comprising the step of outputting the low frequency alternating current from a single power supply with a frequency range of 1,000 Hertz or less.

6. A forge ring rolling and induction heating apparatus comprising:
a ring rolling apparatus for a forge ring rolling of a open cylindrical workpiece;
at least one C-core type inductor, each of the at least one C-core type inductor comprising:
an openable closed magnetic core for insertion around a cross sectional region of the open cylindrical workpiece; and
a solenoidal coil surrounding a cross sectional region of the at least one C-core type inductor;
and
at least one low frequency output alternating current power source connected to the solenoidal coil for each one of the at least one C-core type inductor.

7. The forge ring rolling and induction heating apparatus of claim 6 further comprising an inductor movement apparatus to move the openable closed magnetic core of each one of the at least one C-core type inductors during the forge ring rolling of the open cylindrical workpiece.

8. The forge ring rolling and induction heating apparatus of claim 6 wherein the at least one low frequency output alternating current power source comprises a single power source for all of the at least one C-core type inductor having an output frequency of 1,000 Hertz or less.

9. The forge ring rolling and induction heating apparatus of claim 8 wherein the at least one C-core type inductor comprises two C-core type inductors.

10. The forge ring rolling and induction heating apparatus of claim 9 wherein each of the openable closed magnetic core of each one of the two C-core type inductors comprises a C-shaped and I-shaped sections.

11. The forge ring rolling and induction heating apparatus of claim 6 wherein the at least one low frequency output alternating current power source comprises a single power source for all of the at least one C-core type inductor having an output frequency of 1,000 Hertz or less, the single power source located remotely from the at least one C-core type inductor.

12. The forge ring rolling and induction heating apparatus of claim 6 wherein the at least one low frequency output alternating current power source comprises a separate power source for each one of the at least one C-core type inductor, each of the separate power sources having a synchronous output frequency of 1,000 Hertz or less.

13. The forge ring rolling and induction heating apparatus of claim 12 wherein the at least one C-core type inductors comprises two C-core type inductors.

14. The forge ring rolling and induction heating apparatus of claim 13 wherein the openable closed magnetic core of each one of the two C-core type inductors comprises a C-shaped and I-shaped sections.

15. The forge ring rolling and induction heating apparatus of claim 6 wherein the at least one low frequency output alternating current power source comprises a separate power source for each one of the at least one C-core type inductor, each of the separate power sources having a synchronous output of 1,000 Hertz or less, each of the separate power sources located remotely from each one of the at least one C-core type inductor.

16. A method of forging an annular article with electric induction heating, the method comprising the steps of:
(a) inserting the outer and inner diameters of an open cylindrical workpiece respectively between a drive roll and an idler roll of a forge ring rolling apparatus;
(b) positioning each one of a pair of axial rolls on an opposing end of the open cylindrical workpiece;
(c) applying a first pressure force between the drive and idler roll while rotating the drive roll and applying a second pressure force between the pair of axial rolls to increase the outer and inner diameters of the open cylindrical workpiece and reduce the cross section of the open cylindrical workpiece;
(d) inserting an openable closed magnetic core of at least one C-core type inductor around a cross sectional region of the open cylindrical workpiece; and
(e) supplying a low frequency alternating current at least intermittently to a solenoidal coil surrounding a cross sectional region of each one of the at least one C-core type inductor to establish a magnetic field that couples with a region of the open cylindrical workpiece within the openable closed magnetic core to inductively heat the open cylindrical workpiece while performing step (c).

17. The method of forging an annular article with electric induction heating of claim 16 further comprising the step of moving each one of the at least one C-core inductor during step (c) to maintain the cross sectional region of the open cylindrical workpiece within the openable closed magnetic core of each one of the at least one C-core type inductor as the cross section of the open cylindrical workpiece decreases and the inner and outer diameters of the open cylindrical workpiece increase.

18. The method of forging an annular article with electric induction heating of claim 17 wherein the step of moving each one of the at least one C-core inductor further comprises moving each one of the at least one C-core inductor linearly outwards away from the drive roll along an axis passing through the center of the drive roll without rotation of the central axis of each of the at least one C-core inductor.

19. The method of claim 18 further comprising the step of removing the openable closed magnetic core of each one of the at least one C-core type inductor from around the cross sectional region of the open cylindrical workpiece after forging the annular article.

20. The method of claim 16 further comprising the step of outputting the low frequency alternating current from a single power supply in a frequency range of 1,000 Hertz or less.
